(19) United States
(12) Patent Application Publication
(10) Pub. No.: US 2009/0170598 A1
(43) Pub. Date: Jul. 2, 2009

(54) PERIPHERAL AND GAME FOR HANDHELD DEVICE

(76) Inventors: Gregory Keith Oberg, Troy, NY (US); Jesse Nathaniel Booth, Schoharie, NY (US)

Correspondence Address: CHRISTIE, PARKER & HALE, LLP, PO BOX 7068, PASADENA, CA, 91109-7068, US

(21) Appl. No.: 11/968,587

(22) Filed: Jan. 2, 2008

(51) Int. Cl. A63F 13/00; A63F 9/24

(52) U.S. Cl. 463/31; 463/47

(57) ABSTRACT

A handheld device and peripheral, and game using the handheld device and peripheral. The peripheral includes user inputs, with the peripheral interfacing with the handheld device by way of a handheld device memory port, for example a memory port generally configured for use with game cartridges.

### BACKGROUND OF THE INVENTION

The present invention relates generally to handheld devices and games, and more particularly to a peripheral and a game for a handheld device.

Handheld computerized devices are used by many. Music players, video players, GPS capable devices, cellular telephones, particularly some of the more advanced cellular telephones, and handheld video game players are examples of handheld devices that provide wide-ranging capabilities for use, information, and enjoyment. A relatively small form factor common to handheld devices allows for easy transport of the device and ease of use in a variety of environments. Processing capabilities of the devices allow for devices capable of performing a variety of functions, often with at least some of the functions providing powerful applications.

Often the handheld devices are specialized devices, being directed towards a particular genre of applications, although multiple function handheld devices are becoming ever more common. A popular handheld device application is that of providing a display-based game, such as a video game. Often handheld devices applicable to playing of video games include a number of generic input devices. Generic input devices allow for play of a wide range of games using a common interface.

Unfortunately, the use of generic interfaces may reduce enjoyment of game play or otherwise have a negative impact on game play for particular types of games. In addition, use of generic interfaces may not be suitable for some games at all.

### BRIEF SUMMARY OF THE INVENTION

The invention provides a peripheral for a handheld game device, a handheld game device including a peripheral, and a music game system. In one aspect the invention provides a music game system, comprising a handheld game device with at least one display, a touchscreen for the at least one display, and at least two ports, the handheld device having at least one processor, memory coupled to the processor, and circuitry configured to receive electrical signals from the ports, circuitry to receive touchscreen inputs, circuitry to provide displays on the display, and circuitry to provide audio presentations; a peripheral at least partially inserted into a first port of the at least two ports such that electrical contacts of the peripheral are coupled to electrical contacts of the first port, the peripheral including a plurality of user operable buttons and circuitry for providing status of the buttons to the electrical contacts of the peripheral; and the handheld game device capable of receiving program instructions for a music game, the program instructions including program instructions which configure the at least one processor to: command display on the display of user instruction information including graphical symbols following at least one path; determine compliance with the user instruction information comprising determine if at least one particular user operable button of the plurality of user operable buttons is in a depressed state in response to the user instruction information, the at least one particular user operable button of the plurality of user operable buttons depending on the user instruction; and command presentation of audio, with content of the audio dependent on the determination of compliance with the user instruction information.

In another aspect the invention provides a peripheral for a handheld device, the peripheral comprising a mount forming a first cross-sectional leg; a plurality of user operable input devices along the mount, the plurality of user operable input devices arranged in a substantially linear order; a tongue extending from the mount, the tongue including electrical contacts, the tongue configured for at least partial insertion into a memory port of a handheld game device; circuitry for presenting status of the user operable buttons on at least some of the electrical contacts; a grippable structure forming a second cross-sectional leg, the first cross-sectional leg and the second cross-sectional leg providing a pair of surfaces in an L-shape.

In another aspect the invention provides a handheld device and peripheral for use with game software, comprising a handheld device including a processing element, a display, memory, and at least one port configured to receive a removable memory device, the processing element configurable by program instructions in the memory to execute a game; a peripheral including at least one user operable input device and circuitry to present input device status on at least one electrical contact, the peripheral at least partially insertable into at least one of the at least one port so as to couple the at least one electrical contact to at least one electrical contact of the at least one port.

In another aspect the invention provides a handheld device and peripheral for use with game software, comprising a handheld device including a processor, memory, a display, user input devices, and two memory ports for receiving memory devices; a peripheral including a plurality of buttons, electrical contacts coupleable to electrical contacts of at least one of the two memory ports, and means for presenting status of the buttons on at least some of the electrical contacts.

In another aspect the invention provides a handheld game, comprising a housing including a display, at least one processor, and at least one memory port; a peripheral insertable into and removable from the memory port, the peripheral including a plurality of buttons and configured to present button status information to the processor by way of the memory port; the processor configured to command presentation of user instruction information on the display, the user instruction information providing instruction information as to depression of the plurality of buttons, the processor further configured to determine compliance with the user instruction information and accumulate user points responsive to compliance with the user instruction information.

In another aspect the invention provides a peripheral for a handheld device, comprising a structure with a substantially L-shaped cross-section; a tongue extending from the structure; electrical contacts coupled to the tongue; at least one input device coupled to the structure; and electrical circuitry coupling the at least one input device and at least one of the electrical contacts.

These and other aspects of the invention are more fully comprehended upon review of this disclosure.

### BRIEF DESCRIPTION OF THE DRAWINGS

FIG. 1 illustrates a handheld device with peripheral in accordance with aspects of the invention;

FIG. 2 illustrates a further view of the handheld device of FIG. 1;

FIG. 3 is a semi-block diagram of a peripheral unit in accordance with aspects of the invention;

FIG. 4 is a semi-block diagram of a further peripheral unit in accordance with aspects of the invention;

FIG. 6 is a block diagram of a handheld device in accordance with aspects of the invention;

FIG. 6 is a sketch of a screen shot of a game in accordance with aspects of the invention;

FIG. 7 is a flow diagram of a game related process in accordance with aspects of the invention; and

FIG. 8 is a flow diagram of a process of determining peripheral switch status in accordance with aspects of the invention;

FIG. 9 illustrates a further handheld device with peripheral in accordance with aspects of the invention; and

FIG. 10 illustrates a further view of the handheld device with peripheral of FIG. 9.

### DETAILED DESCRIPTION

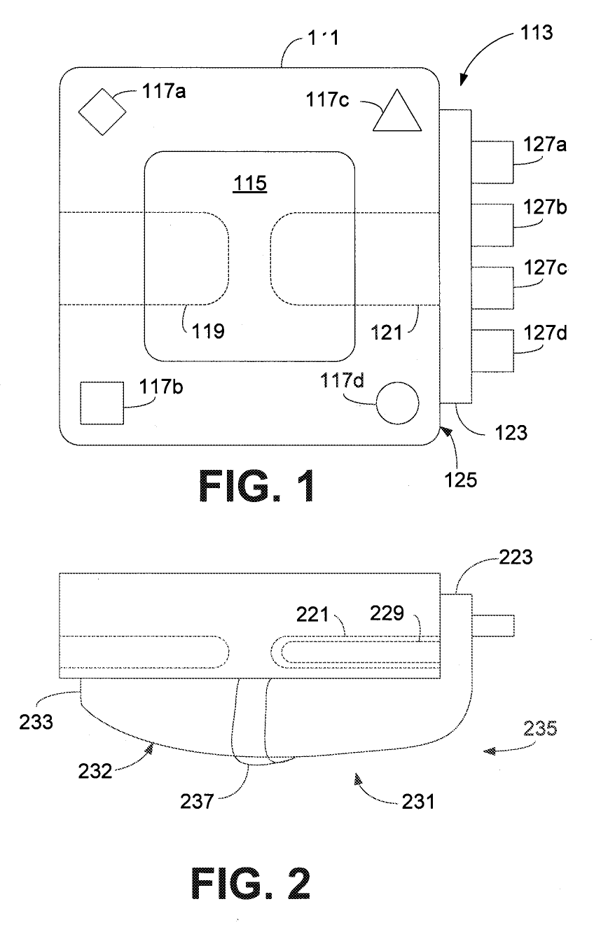

FIG. 1 illustrates a handheld device 111 with a peripheral 113 in accordance with aspects of the invention. In many embodiments the handheld device is primarily intended and generally configured for play of video games. The peripheral is a device that may be used with the handheld device, but is generally not an integral part of or required for operation of the handheld device. As is later discussed, the peripheral may be considered a user input peripheral as the peripheral provides user operable input devices in data communication with the handheld device.

The handheld device includes a display 115 on a first surface largely forming a top of a housing of the handheld device. As is often common with such devices, the handheld device of FIG. 1 includes a touch screen associated with the display, and several input buttons 117a-d, shown with different shapes in FIG. 1, for use as input devices. The device itself usually generally also includes within the housing one or more processors, display drivers, possibly audio drivers, memory for use by the processor and/or the display drivers, and other circuitry.

The handheld device shown in FIG. 1 also includes a first port 119 and a second port 121. In one embodiment the first and second ports are memory ports, and comprise a first memory port and a second memory port. Generally the ports include electrical contacts for electrically coupling with devices or connectors of devices, which for example may be inserted or partially inserted into the ports. The first memory port is generally configured to receive a memory cartridge of a first type and the second memory port is generally configured to receive a memory card of a second type. The use of two memory ports may allow for use of different types of game cartridges, for example, game cartridges from different manufacturers or game cartridges for different devices. Generally the memory ports include electrical contacts for electrical coupling with corresponding electrical contacts of the game cartridges. In most embodiments the memory ports include electrical connectors, and the game cartridges include electrical connectors configured for mating with the electrical connectors of the memory ports. Accordingly, in most embodiments the electrical contacts are provided by way of electrical connectors of the memory ports and game cartridges.

As shown in FIG. 1, the peripheral is coupled to the handheld device by way of the second memory port. The peripheral of FIG. 1 includes a tongue (not shown) extending into the second memory port, although in other embodiments a body of the peripheral device is at least partially insertable into the second memory port. In either case, generally the peripheral is configured so as to have electrical contacts of the peripheral device contact electrical contacts of the second memory port.

As illustrated the peripheral includes a portion 123 extending about a side edge 125 of the handheld device. A number of buttons 127a-d extend from the peripheral device, and the portion 123 may therefore be considered a button mount of the peripheral. In various embodiments input devices other than buttons, for example a slide, a stick, or other input device may be provided in addition to or instead of the buttons. As illustrated, the buttons are about one edge, the side edge as shown, of the handheld device, with a direction of depression of the buttons being toward the handheld device. Thus, for example, a user could hold the device in the left hand, with the butt of the user's palm about or adjacent one side of the device and tips of the user's fingers about or adjacent the buttons. More specifically, as shown in FIG. 1, the button mount is adjacent, and abuts, the side edge of the handheld device, with the buttons extending from the button mount in a direction away from the handheld device. The button mount is therefore between the handheld device and the buttons. In addition, a user may hold and support the peripheral and handheld device in one hand while being able to both view the display of the handheld device and operate the buttons of the peripheral using fingers of the hand holding the peripheral and handheld device.

FIG. 2 illustrates a side view of the handheld device and peripheral of FIG. 1. As may be seen in FIG. 2, the handheld device has a largely rectangular cross-section. Momentarily ignoring a tongue 229 of the peripheral, the peripheral has a somewhat L-shaped cross-section, such that exterior surfaces of the handheld device may be fitted against what may be viewed as interior surfaces of the peripheral. A button mount 223 forms a first cross-sectional leg of the peripheral, and a grippable structure 231, grippable by a user's hand, forms a second cross-sectional leg of the peripheral. The tongue 211 extends from the button mount into the second memory port 221 of the handheld device. The tongue generally includes electrical contacts, usually provided by an electrical connector, for mating with corresponding electrical contacts of the second memory port. The grippable structure 231 may be considered as extending underneath the handheld device as the structure is adjacent a side of the handheld device opposite a display of the handheld device,

As shown in FIG. 2, the structure 231 includes a rounded outer surface 232. Preferably the rounded outer surface is configured to fit in a curved palm, with a tapered end 233 towards a side of the handheld device away from the buttons to provide a small abutment to form an opposing surface for a heel of a user's palm. A forward edge 235 of the peripheral includes a sharp curve for application of an opposing force by a middle section of the fingers, while the tips of the fingers are adjacent the buttons. The rounded outer surface 232 allows a user to support the peripheral and handheld device with one hand underneath the handheld device, as does, alternatively, the abutment and the forward edge. Moreover, the user may operate buttons of the peripheral with fingers of the same hand supporting the peripheral and handheld device, while also viewing a display of the handheld device as the user's hand is underneath the handheld device. In addition, the peripheral includes a strap 237 to loop around the rounded outer surface, with sufficient room for the user's hand, allowing for secure positioning of the hand against the peripheral.

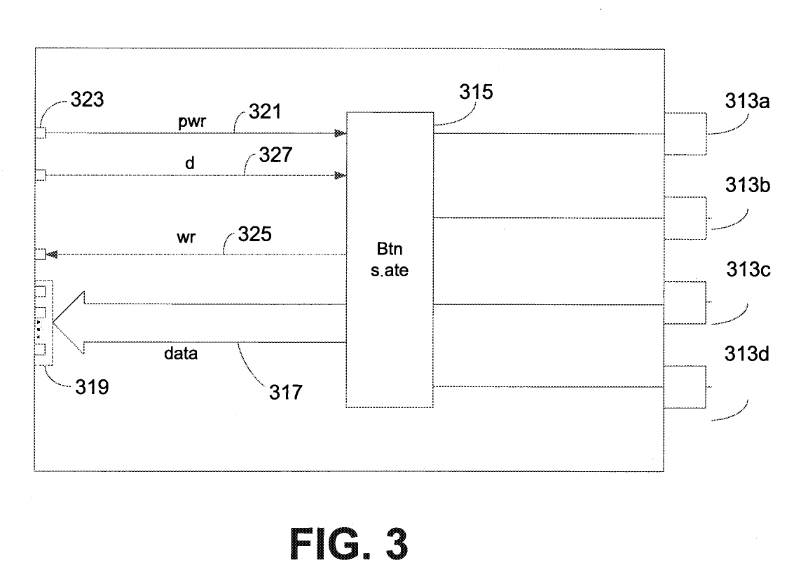

FIG. 3 is a semi-block diagram of a peripheral device in accordance with aspects of the invention. The peripheral device includes one or more input devices on one edge of the device. In FIG. 3 the input devices are shown as buttons 313a-d, but in various embodiments touch sensors, key pads, or other input devices may be used. The buttons are electrically coupled to button state circuitry 315. The button state circuitry includes circuitry for setting data lines 317 to correspond to the state of the buttons. Some embodiments of the peripheral include a battery or other power source. As illustrated in FIG. 3, however, the peripheral includes a power line 321, with associated power contact 323, for receiving power from a handheld device. In some embodiments the button state circuitry simply comprises a resister coupled between the power line and a ground, with the buttons switching data lines between the power line and ground.

In addition, in some embodiments the handheld device may expect a data ready signal, data ready strobe, write signal, or other similar signal when data from the peripheral is available to be read by the handheld device. Generally the data ready signal would be asserted within a predefined time period after receipt of a read signal. Accordingly, in some embodiments the button state circuitry additionally includes circuitry to set a data ready signal on a write line 325 upon a change in button state, or alternatively after receipt of a read strobe or read signal on a read line 327.

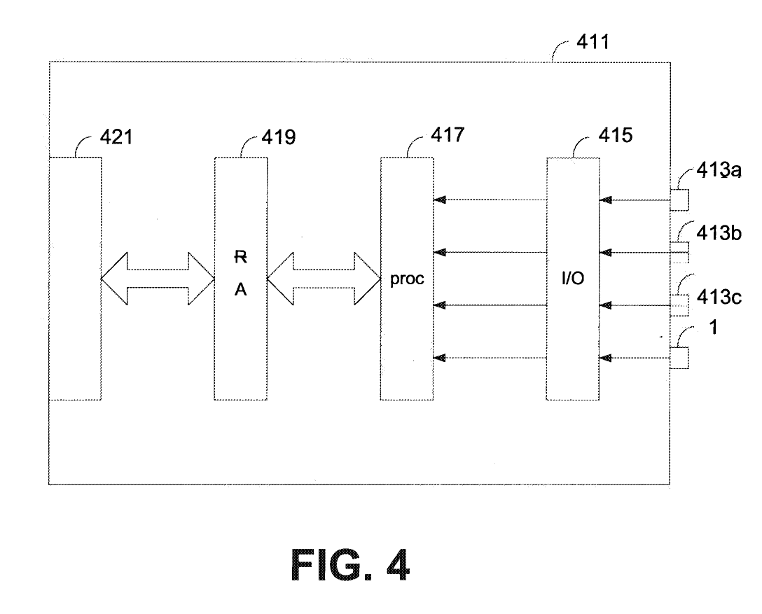

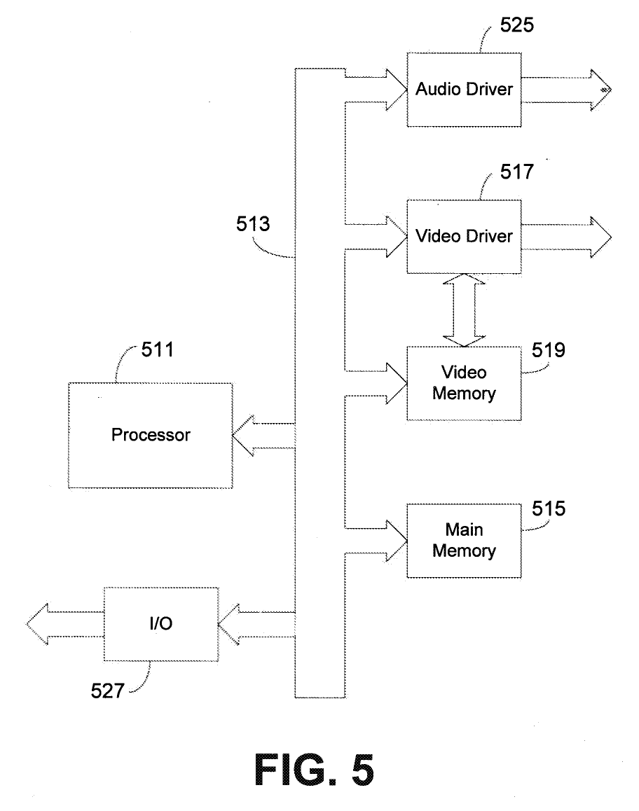

FIG. 4 is an example semi-block diagram of a further peripheral device 411 in accordance with aspects of the invention. The peripheral device includes an input device about one edge, with the input device shown as a plurality of buttons 413a-d. Although buttons are illustrated as the input device in FIG. 4, in other embodiments other input devices, such as a moveable slide, stick or other input device may be provided. Further, in different embodiments different types of buttons may be used. For example, in many embodiments the button is a press and release button, with the button configured to provide a first signal when the button is depressed past a particular point, and a second signal when the button is in an undepressed state. In other embodiments, toggle buttons, toggling states upon each depression, or other types of buttons may be used.

The buttons are electrically coupled to an input circuit, shown in FIG. 4 as input/output circuitry 415. Although some embodiments may utilize output circuitry, for example to provide signals to illuminate lights associated with the buttons, many embodiments do not utilize output circuitry. The I/O circuitry determines button status, and various embodiments may include circuitry for performing debounce operations, providing power to the button circuitry, and for otherwise adjusting signals based on button state for use by other circuitry within the peripheral device. The I/O circuitry provides button status for each of the buttons to processing circuitry 417. In many embodiments the processing circuitry may be included as part of the input/output circuitry, although in some embodiments a separate microprocessor may be provided. In some embodiments the processing circuitry 417 merely provides circuitry for writing to memory.

The peripheral device additionally includes memory, shown as random access memory (RAM) 419 in FIG. 4. The RAM 419 is coupled to handheld device interface 421. The handheld device interface is configured for interoperability with a handheld device. For example, in many embodiments the handheld device interface includes circuitry for processing read request signals from the handheld device, and for providing responsive signals including data from the RAM. It should be recognized, however, that in many embodiments the handheld device interface may merely include data write pins, which are read by the handheld device, with the state of the data write pins set by circuitry within the peripheral device. Accordingly, in some embodiments the RAM, the processing circuitry, and the input/output circuitry may be combined in many embodiments are placed by circuitry setting the data write pins to particular values based on the state of the buttons 413a-d.

FIG. 5 shows a partial block diagram of a handheld device. The handheld device includes a processor 511. A data bus 513 is coupled to the processor and a number of other handheld device components. These other components include main memory 515, a video display driver 517 with associated memory 519. In addition the handheld device includes sound generation circuitry, denoted as an audio driver, 525, and I/O circuitry 527. As illustrated, the I/O circuitry includes I/O processing for handheld device user inputs and for one or more memory ports, although in many embodiments memory port interfacing circuitry is separately provided. In addition, in many embodiments the handheld device includes wireless communication capability, along with associated circuitry.

In operation the processor loads an executable game into main memory from a memory device such as a game cartridge in a first memory port. Accordingly, the processor commands reads of a first memory device, for example a game cartridge, in the first memory port using the I/O circuitry. The processor therefore executes the game loaded in main memory. In some embodiments, however, the executable game is loaded using handheld device wireless communication capability, and the handheld device may include only a single memory port. Alternatively, the handheld device may include only a single memory port, with the game being completely loadable into main memory and no need for continued presence of the first memory device in the memory port during game execution. During game play the processor commands read of a second memory device, or the first memory device in some embodiments, using the I/O circuitry to read an input device status of the peripheral device coupled to the second memory port. In some embodiments the processor may be provided an interrupt upon change of state of the device status in the second memory port, and in other embodiments the processor may periodically read the status of the input devices by way of the circuitry. In other embodiments the processor may be configured to determine the state of the switch inputs based on game conditions.

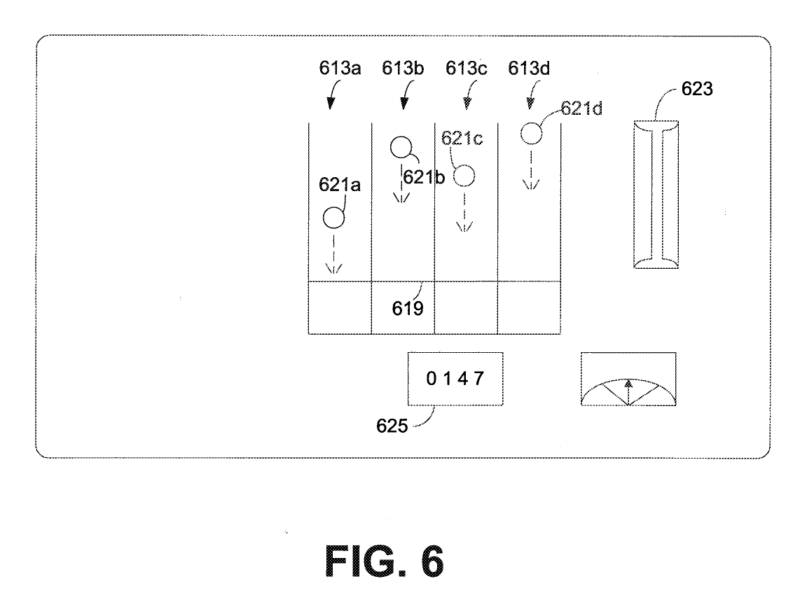

FIG. 6 shows a sample screen shot for an example music game played on the handheld device and using the peripheral. The screen shot is displayed on a display of the handheld device. For handheld devices with multiple displays, with a separate display on each separate housing for example, preferably the screen shot is displayed on the display of the housing to which the peripheral is attached.

In the example music game, graphical symbols move across the display, usually with accompanying audio presentation of a song or portions of a song also being provided by the handheld device. The user is expected to operate input devices of the peripheral, and possibly of the handheld device as well, based on displayed position of the graphical symbols. The graphical symbols therefore provide user instruction information. In most embodiments of the music game, the user is rewarded for compliance with the user instruction information with game points and also further audio presentation of the song or portions of the song, or possibly non-song audio indicating the user did not comply with the user instruction information, allowing the user to “play” the song or portions of the song.

The sample screen shot of FIG. 6 shows four graphical symbols 621a-d. The graphical symbols move across the display in adjacent columnar paths 613a-d. In various embodiments different numbers of graphical symbols, different numbers of paths, or different types of paths may be used, with the paths themselves possibly changing over time. In some embodiments the graphical symbols may be of different colors and shapes, and may only follow a single path or not follow any paths. In addition, as the graphical symbols provide user instruction information, in various embodiments the user instruction information may be presented in other ways using the display, or in some embodiments the user instruction information may be presented using audio information provided by the handheld device.

In the example music game of FIG. 6, as each graphical symbol reaches a predefined area or portion of the display, such as the portion indicated by action line 619, the user may be expected to depress a particular button of the peripheral, or already have the particular button in a depressed state. In many embodiments of the musical game, graphical symbols in each particular path correspond to user instructions for corresponding particular buttons of the peripheral. Thus, a user instruction to depress, or have depressed, a first button may be provided by placement about the action line of a graphical symbol in a first path, a user instruction to depress, or have depressed, a second button may be provided by placement about the action line of a graphical symbol in a second path, and so on.

In some embodiments, and as illustrated in FIG. 6, the paths are arranged in a parallel order, with for example a first path 613a next to a second path 613b, the second path also being next to a third path 613c, and the third path also next to a fourth path 613d. Thus, the paths may be arranged in a linear order. Conveniently the buttons may also be arranged next to one another in a similar manner, for example in a linear order as shown in FIG. 1, such that the relative positions or order of positions of the paths and the relative positions or orders of position of the corresponding buttons may be the same. In various embodiments, however, different graphical symbols may indicate which button or other input device to activate through other correspondences, for example by way of corresponding shapes of the graphical symbols and input devices and/or corresponding colors of the graphical shapes and input devices.

Moreover, in many embodiments the user is also expected to provide a touchscreen input when the graphical symbol reaches the predefined area of the display. The touchscreen input may be provided by depressing the touchscreen about a strum bar displayed on the display. Alternatively, the touchscreen input may be provided by a sequence of depressions across a strum bar 623 displayed on the display, provided for example by dragging or moving a stylus across the touchscreen, simulating for example a strum of a guitar. In such embodiments the handheld device may read the state of the buttons of the peripheral in response to the touchscreen input, and use the state of the buttons, and possibly the state of the touchscreen input, to determine user compliance with the user instruction information. In addition, the handheld device may accumulate user points 625 upon determining user compliance with the user instruction information.

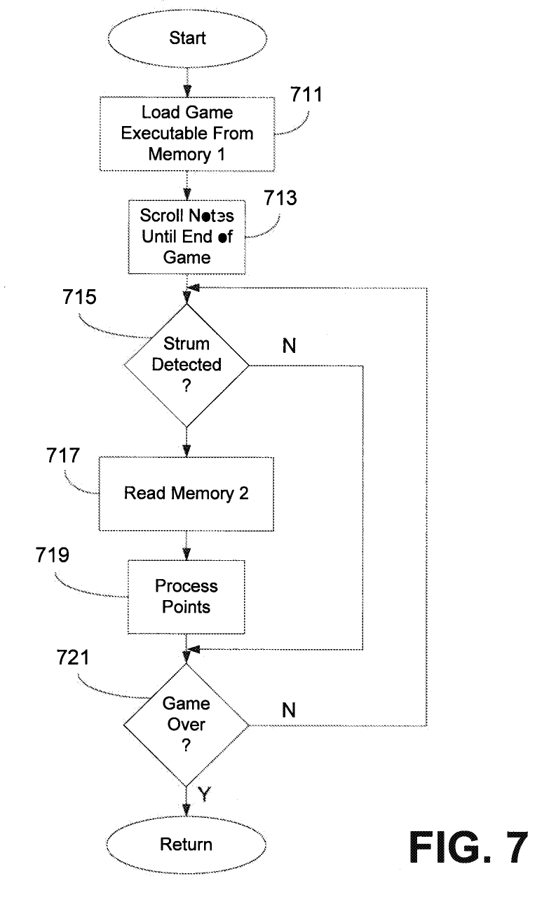

FIG. 7 is a flow diagram of a process in accordance with aspects of the invention. In block 711 a game executable is loaded into memory of a handheld device from a first memory device. In most embodiments the first memory device is accessible through a first memory port. Game data is generally also transferred from the first memory device into memory for retrieval and use during execution of the game.

In several embodiments the game is a music related game, with user instruction information, such as indications of desired button presses, displayed on a display of the handheld device and points provided for proper user response to the user instruction information. The music related game may be, for example, a music game such as discussed with respect to FIG. 6. Accordingly, in block 713 graphical symbols are scrolled across the display. The graphical symbols may be referred to as notes, although it should be recognized that graphical symbols of common or similar position on the display may not correspond to the same musical notes in various embodiments. As indicated in FIG. 7, the notes are scrolled until the end of the game. In various embodiments operation of the game may be performed by a processor executing a variety of instructions while periodically commanding scrolling of the notes or other display actions, or scrolling of the notes may be performed in a timed manner by other display processing elements.

In some embodiments the process determines user compliance with user instructions without requiring strum activation, with process going to block 717 after block 715. As illustrated in FIG. 7, however, in block 715 the process determines if a strum is detected. In some embodiments a processor is configured to receive indications of touchscreen inputs. In such embodiments the processor may determine if a strum is detected if depressions are indicated on appropriate areas of the touchscreen, or alternatively if a sequence of depressions is indicated across a portion of the touchscreen, for example in a first direction or a second direction. A portion of the touchscreen may display, for example, a graphical representation of a strum bar in the general vicinity where the depressions are to be performed. If no strum is detected the process continues to block 621 and determines if the game is over. If the game is not over the process returns to block 615 to determine if a strum is detected.

If a strum is detected, the process in block 717 reads information from a second memory port. In most embodiments a peripheral is inserted in the second memory port of the handheld device, with the peripheral device mimicking operation of a memory device to the extent necessary to allow the processor to receive switch status of the peripheral from the second memory port. In some embodiments the peripheral sets data lines providing data to the handheld device from a device in the memory port with the data lines indicative of switch status of the peripheral.

In block 719 the process determines points related to detection of the strum. In many embodiments the process provides points depending on a correlation between position or expected position of notes scrolling on the screen, correlation between the notes in the defined positions on the screen and switch inputs read from the second memory port, and in some instances timing of a detection of the strum.

In block 721 the process determines if the game is over. If the game is not over the process returns to block 715 to determine if further strums are detected, otherwise the process returns.

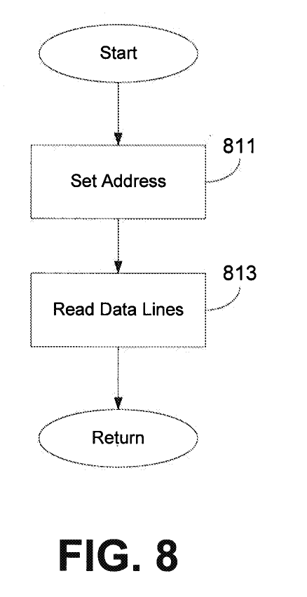

FIG. 8 is a flow diagram of a process for reading switch inputs from a memory port. In block 811 the process sets address lines for the memory port. In block 813 the process reads information on data lines of the memory port.

In various embodiments, the process may not set address lines, or may merely use predefined address lines at all times, with the data lines set independent of address line selections. In other embodiments other processes may be used, for example a processor, or circuitry associated with the processor, may merely periodically scan data lines, or an interrupt line may be set by a device resident in the memory port whenever a switch input of the device changes.

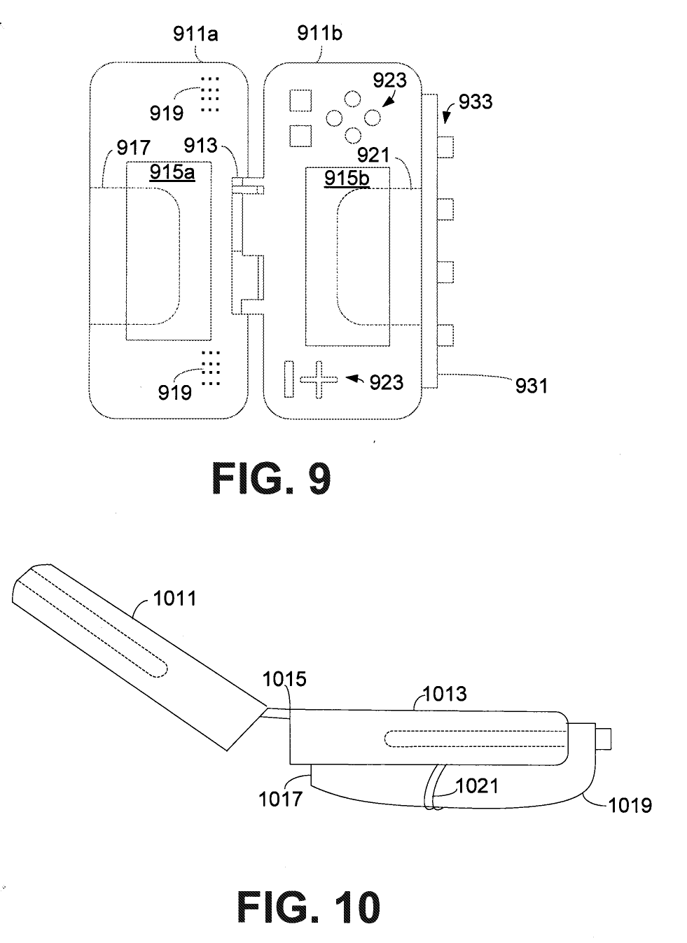

FIG. 9 illustrates a further handheld device with peripheral in accordance with aspects of the invention. As illustrated in FIG. 9 the handheld device has a flip-open configuration, with two largely parallelepiped, or rectangular cube, housings 911a,b connected by a hinge structure 913. Each of the housings of the handheld device includes surfaces which may be considered exterior surfaces, in that they form an exterior of the device when the hinged structure is shut together, and interior surfaces that face each other when the hinged structures are shut together. An example of a commonly used flip-open type device is a Nintendo DS or Nintendo DS Lite, both by the Nintendo Corporation and widely available at consumer electronic retail outlets. It should be recognized that the use of a flip-open type device, as shown in FIG. 9, is exemplary only, and in other embodiments other device structures may be used.

The handheld device of FIG. 9 includes two displays 915a,b, each on one of the housings. A first of the housings additionally includes a first memory port 917 for use with a first memory cartridge, and speakers 919 for generation of sound. The second parallelepiped housing also includes a second memory port 921 for a second memory cartridge. In many embodiments the second memory port is configured to receive a memory cartridge of a different type than the first memory port, although in some embodiments both memory ports are configured to receive the same type of memory cartridge. The second parallelepiped housing also includes input keys 923. In some embodiments a touch screen is also associated with the second display.

A peripheral is coupled to one of the housings, with the peripheral including buttons about a side of the housing away from the hinge structure. The buttons serve as input devices for the peripheral. In various embodiments other input devices are provided instead of or in addition to the buttons.

FIG. 10 illustrates a further view of the handheld device and peripheral of FIG. 9. As shown in FIG. 10, the handheld device includes first and second housings of rectangular cross-section, with the housings coupled by a hinge structure 1015. In most embodiments, the hinge structure includes a passage for electrically coupling the first and second parallelepiped housings. The peripheral is configured to allow for one hand gripping of the handheld device and peripheral. As shown in FIG. 10, the peripheral includes a first abutment surface configured to abut a heel of a palm of a user, and a second somewhat opposing surface 1017 configured for contact with balls of a user's hand or portions of a user's fingers. Accordingly, the handheld device and peripheral may be held and operated as discussed with respect to FIGS. 1 and 2, recognizing that the discussion therein with respect to holding of the device relates to one of the housings of the device of FIGS. 9 and 10. To provide further ease of handling of the combined handheld device and peripheral, a strap is provided, with the strap 1021 intended to be used to wrap around an outer surface of a user's hand to maintain the hand in position against the peripheral. With the user so holding the peripheral, and therefore also the handheld device, the user's finger tips are about the buttons, allowing for depression of the buttons by the user during game play.

Accordingly, the invention provides a peripheral and game for handheld device. Although the invention has been described with respect to specific embodiments, it should be recognized that the invention may be practiced other than as specifically described, with the invention comprising the claims and their insubstantial variations supported by this disclosure.

What is claimed is:

1. A music game system, comprising:
a handheld game device with at least one display, a touchscreen for the at least one display, and at least two ports, the handheld device having at least one processor, memory coupled to the processor, and circuitry configured to receive electrical signals from the ports, circuitry to receive touchscreen inputs, circuitry to provide displays on the display, and circuitry to provide audio presentations;
a peripheral at least partially inserted into a first port of the at least two ports such that electrical contacts of the peripheral are coupled to electrical contacts of the first port, the peripheral including a plurality of user operable buttons and circuitry for providing status of the buttons to the electrical contacts of the peripheral; and
the handheld game device capable of receiving program instructions for a music game, the program instructions including program instructions which configure the at least one processor to: command display on the display of user instruction information including graphical symbols following at least one path; determine compliance with the user instruction information comprising determine if at least one particular user operable button of the plurality of user operable buttons is in a depressed state in response to the user instruction information, the at least one particular user operable button of the plurality of user operable buttons depending on the user instruction; and command presentation of audio, with content of the audio dependent on the determination of compliance with the user instruction information.

2. The music game system of claim 1 wherein at least two of the at least two ports are configured for receiving game cartridges.

3. The music game system of claim 1, wherein the graphical symbols have a visual correspondence to the user operable buttons.

4. The music game system of claim 1, wherein the graphical symbols follow a plurality of paths, each graphical symbol following one of the plurality of paths, wherein the program instructions to determine user compliance with the user instruction information includes program instructions to determine if the at least one particular user operable button of the plurality of user operable buttons is in a depressed state when at least one graphical symbol is in a predefined area of the display, the at least one user operable button of the plurality of user operable buttons depending on the at least one graphical symbol in the predefined area of the display.

5. The music game system of claim 4, wherein at least some portion of each graphical symbol includes a color that corresponds to a color on at least some portion of each user operable button.

6. The music game system of claim 4, wherein the plurality of user operable buttons are arranged in a linear order, the plurality of paths are arranged in a linear order, the linear order of the user operable buttons and the linear order of the plurality of paths determining correspondence between the particular user operable button and the particular path.

7. The music game system of claim 1 wherein the content of the audio is a portion of a song if there is compliance with user instruction information.

8. The music game system of claim 1 wherein the content of the audio is non-song audio if there is not compliance with user instruction information.

9. The music game system of claim 4 wherein determine compliance with the user instruction information further comprises determine if the touchscreen indicates an appropriate input when the graphical symbol is in the predefined area of the display.

10. The music game system of claim 9 wherein the appropriate input is a sequence of depressions across a portion of the touchscreen.

11. The music game system of claim 10 wherein the program instructions further include program instructions to configure the at least one processor to command display of a representation of a strum bar about a portion of the display corresponding to the portion of the touchscreen.

12. The music game system of claim 1 wherein the user operable buttons of the peripheral extend away from a side surface of a housing of the handheld game device, the side surface of the housing of the handheld device being adjacent a top surface of the handheld device, the top surface including the display.

13. The music game system of claim 9 wherein the peripheral includes a structure extending under a bottom surface of the housing of the handheld device, the bottom surface being opposite the top surface of the handheld device.

14. A peripheral for a handheld device, the peripheral comprising:
a mount forming a first cross-sectional leg;
a plurality of user operable input devices along the mount, the plurality of user operable input devices arranged in a substantially linear order;
a tongue extending from the mount, the tongue including electrical contacts, the tongue configured for at least partial insertion into a memory port of a handheld game device;
circuitry for presenting status of the user operable buttons on at least some of the electrical contacts;
a grippable structure forming a second cross-sectional leg, the first cross-sectional leg and the second cross-sectional leg providing a pair of surfaces in an L-shape.

15. The peripheral for a handheld device of claim 14 wherein the user operable input devices comprise buttons.

16. The peripheral for a handheld device of claim 15 wherein the buttons extend in a first direction from the mount.

17. The peripheral for a handheld device of claim 16 wherein the tongue extends in a second direction from the mount, the second direction approximately opposite the first direction.

18. The peripheral for a handheld device of claim 14, wherein the grippable structure includes a rounded outer surface and a tapered end, the tapered end forming an abutment.

19. The peripheral for a handheld device of claim 14 further comprising a strap looped around the rounded outer surface.

20. The peripheral for a handheld device of claim 14 wherein the circuitry for presenting status of the user operable input devices on at least some of the electrical contacts includes memory.

21. A handheld device and peripheral for use with game software, comprising:
a handheld device including a processing element, a display, memory, and at least one port configured to receive a removable memory device, the processing element configurable by program instructions in the memory to execute a game;
a peripheral including at least one user operable input device and circuitry to present input device status on at least one electrical contact, the peripheral at least partially insertable into at least one of the at least one port so as to couple the at least one electrical contact to at least one electrical contact of the at least one port.

22. A handheld device and peripheral for use with game software, comprising:
a handheld device including a processor, memory, a display, user input devices, and two memory ports for receiving memory devices;
a peripheral including a plurality of buttons, electrical contacts coupleable to electrical contacts of at least one of the two memory ports, and means for presenting status of the buttons on at least some of the electrical contacts.

23. A handheld game, comprising:
a housing including a display, at least one processor, and at least one memory port;
a peripheral insertable into and removable from the memory port, the peripheral including a plurality of buttons and configured to present button status information to the processor by way of the memory port;
the processor configured to command presentation of user instruction information on the display, the user instruction information providing instruction information as to depression of the plurality of buttons, the processor further configured to determine compliance with the user instruction information and accumulate user points responsive to compliance with the user instruction information.

24. The handheld game of claim 23 wherein the plurality of buttons correspond in number to a number of paths followed by graphical symbols of the user instruction information, each particular path of the paths followed by a graphical symbol having a correspondence to a particular button of the plurality of buttons.

25. The handheld game of claim 24 wherein the paths are parallel paths.

26. The handheld game of claim 24 wherein the paths vary over time.

27. The handheld game of claim 24 wherein the buttons are arranged linearly.

28. The handheld game of claim 27 wherein the paths are parallel paths, and adjacent paths provide user instruction information to adjacent buttons.

29. The handheld game of claim 23 wherein the plurality of buttons correspond in number to a number of shapes of graphical symbols of the user instruction information.

30. The handheld game device of claim 29 wherein each shape of the graphical symbols has a correspondence to a particular button of the plurality of buttons.

31. A peripheral for a handheld device, comprising:
a structure with a substantially L-shaped cross-section;
a tongue extending from the structure;
electrical contacts coupled to the tongue;
at least one input device coupled to the structure; and
electrical circuitry coupling the at least one input device and at least one of the electrical contacts.

32. The peripheral for a handheld device of claim 31 wherein the tongue include an electrical connector, the electrical contacts being part of the electrical connector.

33. The peripheral for a handheld device of claim 31 wherein the at least one input device comprises a plurality of buttons.

34. The peripheral for a handheld device of claim 33 wherein the plurality of buttons are about a first exterior surface of the structure.

35. The peripheral for a handheld device of claim 33 wherein the plurality of buttons are arranged substantially linearly about a first exterior surface of the structure.

36. The peripheral for a handheld device of claim 34 further comprising a strap about a second exterior surface of the structure.

37. The peripheral for a handheld device of claim 33 wherein the plurality of buttons each have a different shape.

38. The peripheral for a handheld device of claim 33 wherein the plurality of buttons each have a different color.

39. The peripheral for a handheld device of claim 31 wherein each of the plurality of buttons are coupled by the electrical circuitry to a corresponding electrical contact of the electrical contacts.

40. The peripheral for a handheld device of claim 39 wherein the electrical circuitry is configured to present button status of the plurality of buttons on the electrical contacts.
